(19) United States
(12) Patent Application Publication
(10) Pub. No.: US 2009/0194217 A1
(43) Pub. Date: Aug. 6, 2009

(54) CORAL REEF RESTORATION

(75) Inventor: Norman V. FILBERT, Stevensville, MD (US)

Correspondence Address: ROBERTS MLOTKOWSKI SAFRAN & COLE, P.C.;Intellectual Property Department, P.O. Box 10064, MCLEAN, VA, 22102-8064, US

(73) Assignee: SHELLBOND LLC, Stevensville, MD (US)

(21) Appl. No.: 12/023,665

(22) Filed: Jan. 31, 2008

(51) Int. Cl. B29C 65/00

(52) U.S. Cl. 156/61

(57) ABSTRACT

A method of restoring a coral reef comprises securing a coral reef fragment to a support with a bonding composition comprising a particulate material produced by heating an animal skeletal material to a temperature of at least 1000° C. and hydrating the heated skeletal material.

### FIELD

This invention relates to a method of building, establishing, restoring and/or repairing coral reefs.

### BACKGROUND

Coral reefs are extremely complex marine ecosystems which are home to numerous aquatic species. Coral reefs are thought by many scientists to be the most biologically diverse, species-rich and productive ecosystems on the earth. Coral reefs occupy approximately two-tenths of a percent (0.2%) of the world's ocean surfaces. Moreover, it is estimated that coral reefs are home to nearly a million marine species, including a quarter of all fish species.

Corals are divided into two types: hard corals and soft corals. Hard corals, such as staghorn, elkhorn, and pillar corals, are stationary on the ocean floor and have rigid exoskeletons, or corallites, that protect the soft delicate bodies within their interior. Soft corals, or gorgonians, such as sea fans, sea whips, and sea rods, are also stationary on the ocean floor, but they lack an exoskeleton. The soft corals sway back and forth under the influence of the currents.

Coral reefs provide several important benefits to the world's population. These benefits include tourism, private and commercial fishing, mainland and island protection, medicines, and ecological indications. Many people travel to coral reefs to snorkel, scuba-dive, and fish. For example, many island countries in the Pacific and Indian Oceans and in the Caribbean Sea derive a substantial portion or their income from the tourism attracted by the nearby coral reefs. In addition, coral reefs provide protection from coastal damage from intense wave action, such as coastal erosion and flooding. Older reefs have facilitated the formation of lagoons and calm shorelines where seagrass beds and mangrove trees flourish to provide shelter and habitat for numerous species at the coastal/aquatic interface. Coral reefs are also a source of many important pharmaceutical breakthroughs. It is estimated that nearly one-half (½) of the potential pharmaceuticals presently being explored are from the oceans—many of which are found near coral reefs.

However, coral reefs around the world are declining due to human-caused changes in water quality which increase water temperatures, nutrients, and sediments, as well as from direct physical damage from dredging, anchoring, destructive fishing techniques, and other intensifying human stresses. Most reefs near populated areas or tourism resorts are dying or dead. High temperatures related to global warming and the outbreak of coral diseases are taking severe tolls on all reefs, especially in remote reefs which have not been previously directly affected by humans. In recent years, there has been massive death of corals due to unprecedented hot water conditions across the southern Pacific, Atlantic, and Indian Oceans. This is causing severe declines in catches, stocks, sizes, and diversity of fishes, greatly increased erosion of beaches and coastal structures, and loss of tourism revenues. If coral reefs continue to deteriorate the economies of over 100 coral reef countries will be severely affected, and several could vanish entirely due to rising sea level. There is therefore intense interest around the world in developing methods of reversing the decline of coral reefs as well as in repairing and restoring damaged reefs.

One known method of reef restoration focuses so-called “artificial reefs”, such as the perforated cement dome structure disclosed in U.S. Pat. No. 5,215,406 and the hollow, spherical, concrete reef ball disclosed in U.S. Pat. No. 5,564,369. However, such artificial reef structures are found to generate few hard corals or a normal diversity of reef organisms: instead they are sparsely covered with a limited variety of sponges, soft corals, and other weedy organisms. Such structures may provide hiding spaces for fish, but they steadily deteriorate as they rust, corrode, and leach toxic chemicals, crack, crumble, and eventually collapse, turning into projectiles which damage real reefs in storms. Despite claims made on short term results, such projects show very high mortality of transplanted corals within a year, and none are known to have increased the abundance of living corals over significant areas or to have created habitat for a normal reef ecosystem. In addition their high cost makes them unfeasible on a large scale.

An alternative method of reef restoration involves coral transplantation. Generally, this method involves initially culturing coral fragments generated by hurricanes and other disturbances in laboratory and field nurseries followed by transplantation of the cultured fragments at degraded reef sites. However, one problem associated with this restoration method involves finding an effective way of securing the reef fragments against wave action and other physical impact both during the culturing process and at the final reef site. Existing proposals have tended to use either epoxy resins or concrete to secure the reef fragments to the reef or a man-made support, but the effectiveness and environmental desirability of these adhesives remain in question.

In U.S. Pat. No. 4,875,938 there is described a method of making a cementitious binder for use in mortars comprising heating marine shell material to about 2100 to 2350° F. (1150 to 1290° C.); allowing the shell material to cool to ambient temperature; mixing water with the cooled shell material in the ratio of about one part of water by volume to about five parts of shell material by volume; allowing said mixture to spontaneously heat; and monitoring the heat level of said mixture until it commences to cool and as it cools is converted into a dry, substantially white, powdery material that is substantially of the consistency of talcum powder and is useful as a binder in mortar.

According to the present invention it has now been found that the powdery product of the process described in U.S. Pat. No. 4,875,938 is effective as a bonding agent in joining coral fragments to a support. The resultant joint is of high strength, and does not exhibit the tendency to crack experienced with cement mortar joints. In addition, being produced from an animal skeletal material, the product is environmentally friendly and is found to encourage the growth of marine life. Moreover, it has been found that the process of U.S. Pat. No. 4,875,938 can be used with a wider variety of animal skeletal materials than shells thereby markedly expanding the scope of raw materials that can be used in the process.

### SUMMARY

In one aspect, the invention resides in a method of securing a coral reef fragment to a support comprising providing between the coral reef fragment and the support a bonding composition comprising a particulate material produced by heating an animal skeletal material to a temperature of at least 1000° C. and hydrating the heated skeletal material.

In another aspect, the invention resides in a method of restoring a damaged coral reef, the method securing a coral reef fragment to a support associated with the damaged reef using a bonding composition comprising a particulate material produced by heating an animal skeletal material to a temperature of at least 1000° C. and hydrating the heated skeletal material.

Conveniently, said particulate material is produced by a process comprising:

(a) heating an animal skeletal material to a temperature of at least 1000° C. for a time sufficient to convert at least part of the calcium carbonate in the skeletal material to calcium oxide and produce a calcined product; and

(b) contacting at least part of said calcined product with water to produce the particulate material containing calcium hydrate.

Conveniently, said skeletal material is an exoskeletal material, such as the shell of a marine animal or a poultry egg.

In a further aspect, the invention resides in a process for culturing coral comprising

(a) securing a coral reef fragment to a support with a bonding composition comprising a particulate material produced by heating an animal skeletal material to a temperature of at least 1000° C. and hydrating the heated skeletal material; and

(b) contacting said supported coral reef fragment with a coral culture medium under conditions effective to cause additional coral to grow around said fragment.

### DETAILED DESCRIPTION OF THE EMBODIMENTS

Described herein is a method of securing a coral reef fragment to a support using a bonding composition comprising a particulate material produced by heating an animal skeletal material to a temperature of at least 1000° C. and hydrating the heated skeletal material. The support may be a man-made structure used to hold the coral reef fragment in a culture medium during growth of additional coral material around the fragment in a coral nursery. Alternatively, the support may be associated with a damaged coral reef, either as being a natural component of the reef or as a man-made structure anchored in place adjacent the damaged reef.

The skeletal material used in the adhesive composition can be either part or all of the endoskeletal material of an animal, such as the bones of a domestic or farm animal, such as a cow, or can be an exoskeletal material, such as the shell of a marine animal or the shell of a bird's egg, such as a poultry egg. Particularly preferred skeletal materials include marine shells, such as clam and oyster shells, and poultry egg shells.

The skeletal material is initially heated in a suitable kiln to a temperature of at least 1000° C., for example from 1100° C. to 1500° C., typically from 1150° C. to 1300° C. to remove organic material and to convert at least part, and preferably all, of the calcium carbonate in the skeletal material to calcium oxide. In this respect, there is no requirement that the skeletal material be separated from the rest of the animal before being heated in the kiln since, at the high temperatures involved, all residual organic material will be burned off. In addition, the skeletal material can be introduced into the kiln without prior treatment or, more preferably, can be crushed, chopped or otherwise comminuted before being introduced into the kiln.

The time required for the conversion of the skeletal material to calcium oxide will depend on many factors, including the rate of heating and final temperature of the kiln, the type of skeletal material and the degree of conversion sought. In general, however, the skeletal material need only be heated to the appropriate final temperature and does not need to stay at that temperature for any length of time for significant conversion of the calcium carbonate in the skeletal material to calcium oxide. When the calcination is complete, the skeletal material is allowed to cool throughout back down to ambient temperature. The skeletal material at this stage can be coarse, or granular substance in which, in the case of marine shells being used as the skeletal material, recognizable flakes of the shells in their respective colors, e.g., white for clam and egg shell, cinnamon or brownish for oyster shells, etc. can be readily detected.

After the calcined skeletal material has cooled to, or approaching, ambient temperature, water, which can be either fresh or saline and can even be taken directly from a brackish source, such as a bay, or from the open ocean, is mixed with the calcined skeletal material to convert the calcium oxide to calcium hydrate, Ca(OH)₂. As is well known, this hydration reaction is highly exothermic and can result in a rapid rise in the temperature of the skeletal material/water mixture and the evolution of steam. The relative ratio of the water to the calcined skeletal material is not critical but in general at least 1 part by volume, preferably 2 to 8 parts by volume, more preferably 4 to 6 parts by volume, most preferably about 5 parts of the calcined skeletal material are mixed with 1 part by volume of water.

The temperature of the mixture of the calcined skeletal material is monitored during the hydration reaction and typically rises spontaneously to almost 200° C., resulting in rapid evolution of steam, and then remains at this level for a period of time as the hydration reaction proceeds. When hydration is complete, the temperature starts to fall and, at a visually recognizable point during this fall of the temperature, the previously coarse, vari-colored calcined skeletal material converts, without further treatment as by crushing in a ball mill, into a white or substantially white homogeneous, fluffy powdery calcium hydrate.

The resultant calcium hydrate is used to produce a bonding composition by mixing the hydrate with water, typically in an amount between 1 and 2 parts by volume water for each 10 parts by volume of the hydrate. The water employed can be saline or brackish, including sea water. The bonding composition may also contain with one or more inert fillers, such as sand and gravel, typically in an amount between 2 and 4 parts by volume filler for each part by volume of the hydrate. In addition, a mineral, vegetable or fish oil, especially a fish oil and particularly menhaden oil, is preferably added to the composition, suitably in an amount between 0.1 and 0.7 parts by volume oil for each part by volume of the hydrate. The product is mixed and additional hydrate is added until there is no surface oil visible and the mixture takes on a “mortar” like appearance and consistency. The resultant bonding composition can then applied to the surfaces of the support and coral reef fragment to be joined. This can be effected above or below water. After the bonding composition has set, a strong, crack resistant joint is produced between the support and coral reef fragment.

The present method may be used to directly repair a damaged coral reef, by using the bonding composition to secure a coral reef fragment to a support associated with the damaged reef. In such a case, the support can be a natural component of the reef or a man-made structure anchored in place adjacent the damaged reef. The man-made support structure can also be produced from the present bonding composition.

Alternatively, the method described herein can comprise one step in a coral culturing process, in which the present bonding composition is used to secure a coral reef fragment to a support associated with a coral nursery. In this case, the support is used to retain the coral reef fragment in contact with a coral culture medium under conventional conditions effective to cause additional coral to grow around the fragment. The cultured coral fragment can then be used to repair a damaged reef using the bonding composition described herein.

In yet a further embodiment, the present bonding composition can be used to construct or establish a new coral reef, with or without the use of existing coral fragments. In this case, a coral support structure is produced having at least a surface coating produced from the present bonding composition and then the support structure is immersed in sea water. Alternatively, the entire support can be produced from the present bonding composition. Particularly, where the bonding composition contains an oil, such as a vegetable or fish oil, especially menhaden oil, it is found that coral-forming marine organisms grow rapidly on the support structure.

The invention will now be more particularly described with reference to the following Example.

### EXAMPLE

10 lbs (4.5 kg) of oyster shells are placed in a kiln and are heated to 2150° F. to 2350° F. (1177° C. to 1288° C.). The kiln is then turned off and allowed to cool to room temperature. After cooling, the heated shell, which is in the form of coarse cinnamon or brownish flakes, is removed from the kiln and placed in a bucket. Water is added to the bucket in amount to provide about five parts by weight of heated shell to each part by weight of water. The temperature of the water rapidly rises to almost 100° C., with significant amounts of steam being emitted from the bucket. The temperature in the bucket then begins to fall and after the temperature returns to ambient the contents of the bucket are removed and found to be in the form of a fine white or substantially white homogeneous, powder. The yield of the fine white powder, calcium hydrate, is about 8 lbs (3.6 kg).

A bonding composition is formed by mixing the following components in a blender:

(a) 8 lbs (3.6 kg) of the calcium hydrate produced as above;

(b) 2.5 to 3.5 gallons (9.5 to 13 l) of water;

(b) 16 to 24 lbs (7.2 to 10.9 kg) of a filler in the form of agricultural (Ag) lime or sand; and

(c) 1 quart (0.9 l) of menhaden oil.

The water and oil are combined initially and then the filler and calcium hydrate are added. The resultant mixture is then blended and more filler and calcium hydrate are added until there is no oil visible on the surface of the mixture and any residual surface water becomes clear. The resultant “mortar like” mixture is applied to the surface of a concrete post and exposed to sea water. Animal and algae growth on the post is evident in two days.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

What we claim is:

1. A method of securing a coral reef fragment to a support comprising providing between the coral reef fragment and the support a bonding composition comprising a particulate material produced by heating an animal skeletal material to a temperature of at least 1000° C. and hydrating the heated skeletal material.

2. The method of claim 1 wherein the skeletal material is endoskeletal material.

3. The method of claim 1 wherein the skeletal material is exoskeletal material.

4. The method of claim 3 wherein the exoskeletal material comprises a shell of a marine animal or a poultry egg.

5. The method of claim 1 wherein said temperature is from about 1100° C. to about 1500° C.

6. The method of claim 1 wherein the bonding composition also comprises a vegetable or fish oil.

7. The method of claim 1 wherein said particulate material is produced by a process comprising:
(a) heating an animal skeletal material to a temperature of at least 1000° C. for a time sufficient to convert at least part of the calcium carbonate in the skeletal material to calcium oxide and produce a calcined product; and
(b) contacting at least part of said calcined product with water to produce the particulate material containing calcium hydrate.

8. A method of restoring a damaged coral reef, the method comprising securing a coral reef fragment to a support associated with the damaged reef using a bonding composition comprising a particulate material produced by heating an animal skeletal material to a temperature of at least 1000° C. and hydrating the heated skeletal material.

9. The method of claim 8 wherein the skeletal material is endoskeletal material.

10. The method of claim 8 wherein the skeletal material is exoskeletal material.

11. The method of claim 10 wherein the exoskeletal material comprises a shell of a marine animal or a poultry egg.

12. The method of claim 8 wherein said temperature is from about 1100° C. to about 1500° C.

13. The method of claim 8 wherein the bonding composition also comprises a vegetable or fish oil.

14. The method of claim 8 wherein said particulate material is produced by a process comprising:
(a) heating an animal skeletal material to a temperature of at least 1000° C. for a time sufficient to convert at least part of the calcium carbonate in the skeletal material to calcium oxide and produce a calcined product; and
(b) contacting at least part of said calcined product with water to produce the particulate material containing calcium hydrate.

15. A process for culturing coral comprising
(a) securing a coral reef fragment to a support with a bonding composition comprising a particulate material produced by heating an animal skeletal material to a temperature of at least 1000° C. and hydrating the heated skeletal material; and
(b) contacting said supported coral reef fragment with a coral culture medium under conditions effective to cause additional coral to grow around said fragment.

16. The process of claim 15 wherein the skeletal material is endoskeletal material.

17. The process of claim 15 wherein the skeletal material is exoskeletal material.

18. The process of claim 17 wherein the exoskeletal material comprises a shell of a marine animal or a poultry egg.

19. The process of claim 15 wherein said temperature is from about 1100° C. to about 1500° C.

20. The process of claim 15 wherein said particulate material is produced by a process comprising:
(a) heating an animal skeletal material to a temperature of at least 1000° C. for a time sufficient to convert at least part of the calcium carbonate in the skeletal material to calcium oxide and produce a calcined product; and
(b) contacting at least part of said calcined product with water to produce the particulate material containing calcium hydrate.

21. A process of building a coral reef, the process comprising:
(a) providing a coral support structure having at least a surface layer produced from a bonding composition comprising a particulate material produced by heating an animal skeletal material to a temperature of at least 1000° C. and hydrating the heated skeletal material; and
(b) immersing said coral support structure in sea water whereby coral-forming organisms grow on said surface layer.

22. The process of claim 21 wherein the skeletal material is endoskeletal material.

23. The process of claim 21 wherein the skeletal material is exoskeletal material.

24. The process of claim 23 wherein the exoskeletal material comprises a shell of a marine animal or a poultry egg.

25. The method of claim 21 wherein the bonding composition also comprises a vegetable or fish oil.
